(19) United States
(12) Patent Application Publication
(10) Pub. No.: US 2011/0281147 A1
(43) Pub. Date: Nov. 17, 2011

(54) INSULATING RING AND LITHIUM ION BATTERY HAVING THE SAME

(75) Inventors: Huajun Sun, Shenzhen (CN); Yun Wang, Shenzhen (CN)

(73) Assignee: BYD Co. Ltd., Shenzhen (CN)

(21) Appl. No.: 13/131,744

(22) PCT Filed: Sep. 27, 2009
(86) PCT No.: PCT/CN2009/074265

§ 371 Date: Jul. 28, 2011

(30) Foreign Application Priority Data
Nov. 27, 2008 (CN) 200820214048

(51) Int. Cl. H01M 10/02; H01M 2/14; H01M 2/30; H01M 2/02; H01M 2/36

(52) U.S. Cl. 429/82; 429/179; 429/122

(57) ABSTRACT

The present invention discloses an insulating ring for a lithium ion battery, comprising: a circular ring body; a core rod positioning member configured at a central part of the circular ring body for positioning a core rod of the lithium ion 5 battery; and at least a tab hole configured to be adjacent to the core rod positioning member through which a tab of the core rod is penetratable. Further, a lithium ion battery having the insulating ring is also disclosed. With the present invention, battery safety performance is enhanced greatly.

### CROSS-REFERENCE TO RELATED APPLICATIONS

This application claims priority to Chinese Patent Application No. 200820214048.2, filed on Nov. 27, 2008, the entire contents of which are incorporated herein by reference.

### TECHNICAL FIELD

The present invention relates to a lithium ion battery, more particularly to an insulating ring for a cylindrical lithium ion battery and a lithium ion battery having the same.

### BACKGROUND OF THE INVENTION

Conventionally, cylindrical lithium ion batteries, or cylindrical lithium ion secondary batteries, having high safety performance and excellent properties are widely used in the cordless portable device such as digital camera, notebooks and so on. As the high safety performance and excellent properties of the batteries are required, research on the cylindrical lithium ion secondary batteries receives much concern.

The insulating ring used at an end of the cylindrical lithium ion secondary batteries is an important component of the whole structure, and there are many patents on the component improvements. FIG. 1 shows a conventional insulating ring 1′ of the cylindrical lithium ion secondary batteries. The insulating ring 1′ comprises a central hole 2′ and a plurality of via holes 3′ distributed in a circumferential direction.

The above mentioned structure is beneficial in improving injecting efficiency of the electrolyte. However while the battery is impacted or vibrated, the tabs in the core may move randomly and also a core rod of the core may move therewith, thus the tab may directly contact with the core rod and cause a short circuit and may affect safety performance of the battery.

### SUMMARY OF THE INVENTION

In viewing thereof, the present invention is directed to solve at least one of the problems existing in the prior art. Accordingly, the present invention needs to provide an inventive insulating ring for a lithium ion battery and a lithium ion battery having the same, which may enhance safety performance of the lithium ion battery.

According to an embodiment of the invention, an insulating ring for a lithium ion battery is provided to solve at least one of the technical problems of the invention, comprising a circular ring body, a core rod positioning member and at least a tab hole. The core rod positioning member is configured at a central part of the circular ring body for positioning a core rod of the lithium ion battery. The tab hole is configured to be adjacent to the core rod positioning member through which a tab of the core rod is penetratable.

According to an embodiment of the invention, a lithium ion battery comprising a cylindrical shell encapsulated with electrolyte, a battery core positioned in the cylindrical shell formed with a central hole, a core rod penetrating through the central hole of the battery core, and an insulating ring as described hereinabove. The core rod has a protruding tab. The core rod may be tightly positioned by the core rod positioning member with the protruding tab penetrating through the tab hole respectively.

The insulating ring in the present invention has a positioning member formed the center of the circular ring body. The positioning member comprises at least a protruding part. The positioning protruding part can be formed as a positioning groove or a positioning hole or clamping parts. And the insulating ring has a tab hole. The tabs of the lithium ion battery are led out therefrom and located by the tab holes. The core rod may be located by the positioning groove or clamping component. Therefore while the battery is impacted or vibrating, the movement of the tab and core rod may be avoided, thus the direct contact of the tab and the core rod may be avoided and short circuit may be avoided accordingly. So the safety performance of the battery may be effectively improved.

Additional aspects and advantages of the embodiments of present invention will be given in part in the following descriptions, become apparent in part from the following descriptions, or be learned from the practice of the embodiments present invention.

### DESCRIPTION OF THE DRAWINGS

These and other aspects and advantages of the invention will become apparent and more readily appreciated from the following descriptions taken in conjunction with the drawings in which:

FIG. 1 shows a front perspective view of a conventional insulating ring for a lithium ion battery;

FIG. 2 shows a front perspective view of an insulating ring for a lithium ion battery according to an embodiment of the invention;

FIG. 3 shows an exploded perspective view of the insulating ring in FIG. 1 and a core rod of a lithium ion battery before assembling according to an embodiment of the invention,

FIG. 4 shows a cross sectional view of a core in a lithium ion battery according to an embodiment of the invention,

FIG. 5 shows a core of a cylindrical lithium ion battery and an insulating ring after assembling according to an embodiment of the invention; and

FIG. 6A shows an enlarged view of part A indicated in FIG. 4 according to an embodiment of the invention, and

FIG. 6B shows an enlarged view of Part A indicated in FIG. 4 according to another embodiment of the invention.

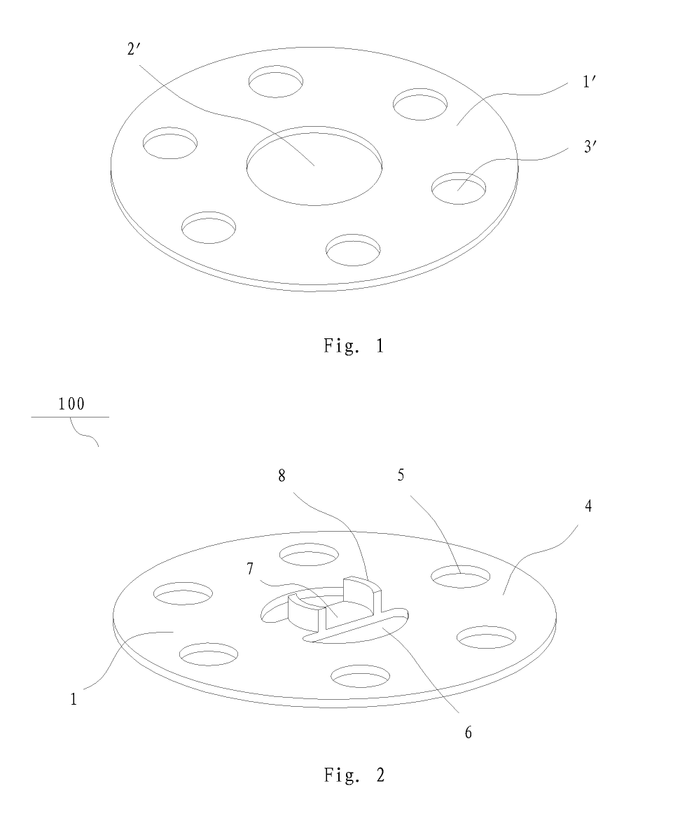

### DETAILED DESCRIPTION OF THE EMBODIMENTS

The aforementioned features and advantages of the invention as well as additional features and advantages thereof will be more clearly understood hereafter as a result of a detailed description of the following embodiments when taken conjunction with the drawings.

The present invention provided an insulating ring 100. According to an embodiment of the invention, FIG. 2 shows a insulating ring 100. The insulating ring 100 has a circular ring body 4, a positioning member in the center for positioning a core rod 9 of the lithium ion battery. The positioning member comprises at least a positioning protruding part 8. The positioning member is used to locate the core rod 9 of the cylindrical lithium ion battery (not shown). The insulating ring 100 has at least a tab hole 6. While the insulating ring 100 is applied in the cylindrical lithium ion battery, the tab 11 is lead out at an end of the battery. Two tab holes 6 may be set on the insulating ring at two lateral sides of the positioning protruding part 8. If the tabs 11 are led out from two ends of the battery, one tab hole 6 can be set on the insulating ring 100.

The corresponding portion of insulating ring 100 under the protruding part 8 is equivalent to a supporting part 7. A plurality of the protruding parts 8 may be formed on the circular ring body 4. While there is one positioning protruding part, it is equivalent to a positioning hole or sleeve (not shown) to locate the battery core rod. While there are two positioning protruding parts 8, it is equivalent to a positioning groove to locate the battery core rod 9. While there are four (or more) positioning protruding parts, it is equivalent to a clamping component to locate the battery core rod 9.

In an embodiment of the invention, there are two positioning protruding parts 8 and the two protruding parts 8 form a positioning groove, thus it is easy for design and manufacture. The positioning protruding part 8 has a height of 1-3 mm, the thickness of which is about 0.2-0.5 times of the thickness of the insulating ring 100. According to an embodiment of the invention, the positioning protruding part 8 may be integrally formed with the insulating ring 100. In this case the whole insulating ring 100 can be formed by injection molding and it is very convenient for manufacture.

Further, a plurality of via holes 5 may be configured along a circumferential direction of the insulating ring for injecting electrolyte. According to some embodiments, the plurality of the via holes 5 are located along the circumferential direction of the insulating ring 100 at even intervals. The shape of the via holes 5 can be one selected from circle, sector, quadrangle, triangle, and circular-arc. While the insulating ring 100 is applied in the lithium ion batteries, the via holes 5 may be used for injecting electrolyte, which may improve the injecting efficiency of the electrolyte.

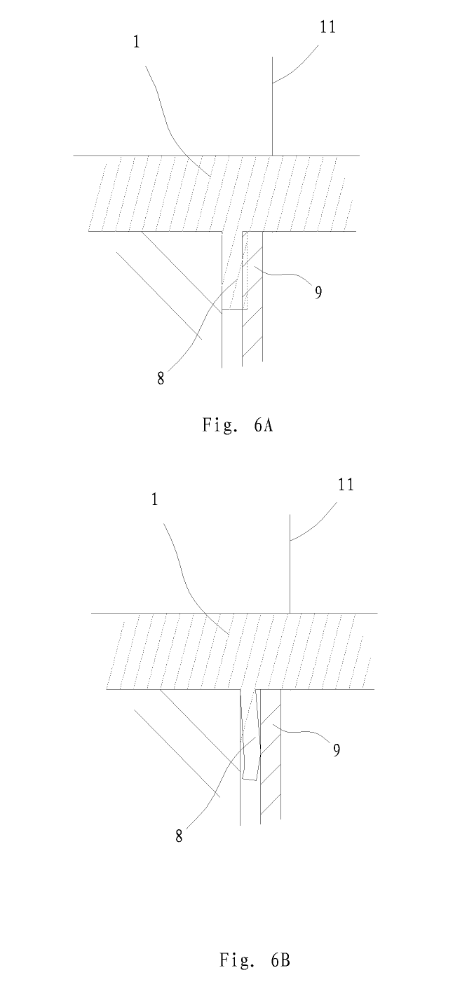

As shown in FIG. 6A, according to an embodiment of the invention, the protruding part 8 may be substantially interference fitted with an outer wall of the core rod 9. As shown in FIG. 6B, according to an embodiment of the invention, the protruding parts 8 are flexible formed to tightly press an outer wall of the core rod 9 when the core rod 9 is inserted therebetween.

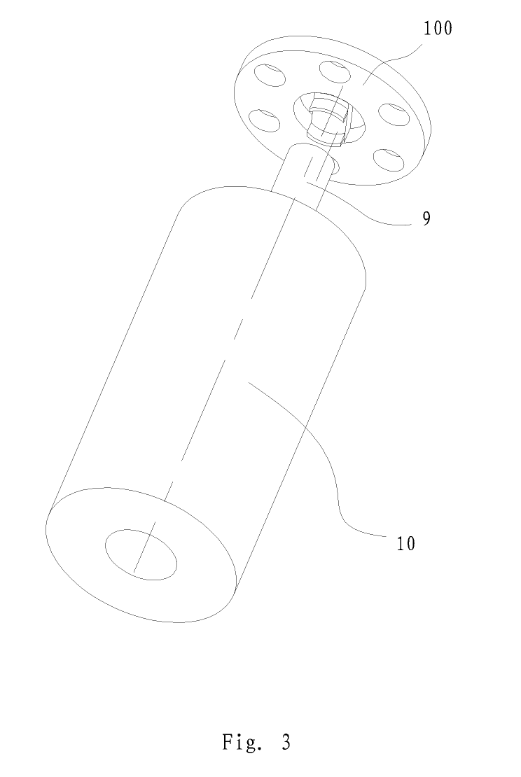

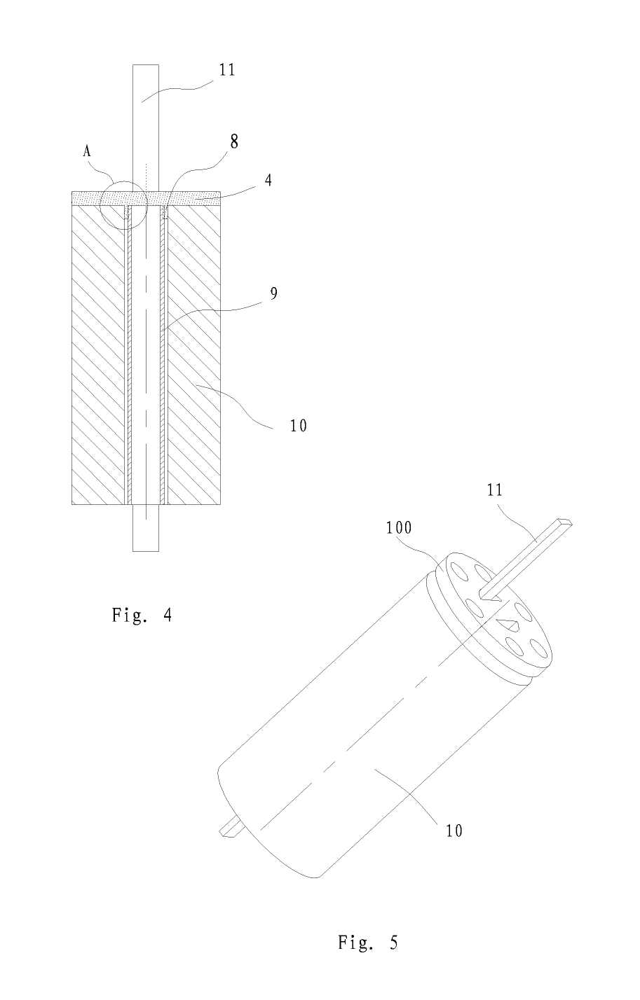

The present invention further provides a lithium ion battery comprising: a cylindrical shell, a battery core 10, a core rod 9, a insulating ring 100 and electrolyte. The battery core 10 is disposed in the shell. The battery core 10 is formed by coiling a positive plate, a separator and a negative plate. The core rod 9 is inserted in the center of the battery core 10. The battery core 10 has a leading out tab 11. As shown in FIG. 3 and FIG. 4, the insulating ring 100 is the insulating ring 100 in the present invention. The core rod 9 matches the protruding part 8 of the insulating ring 100. The positioning protruding part 8 fixes the core rod 9 to avoid movements of the core rod 9 and the tabs in the battery while the battery is impacted or vibrating. As shown in FIG. 5, the tab 11 is led out through the tab hole 6 of the insulating ring 100, the hole 6 holds and locates the tab 11 so that the tab 11 will not move easily.

As shown in FIG. 2, an insulating ring 100 is provided and the ring 4 has six via holes 5; the centers of the via holes 5 are located at the concentric circle of the insulating ring. The via holes 5 are located on the surface of insulating ring 100 at the same intervals. There may be a positioning member in the center of the insulating ring 100. The positioning member comprises two sector-shaped positioning protruding parts 8. The two sector-shaped protruding parts 8 are faced with each other, forming a positioning groove. The height of the sector-shaped positioning protruding part 8 is about 3 mm. The thickness of part 8 is about 0.2 times of the thickness of the insulating ring 100. Besides there are two tab holes 6 at two sides of the sector-shaped positioning protruding part 8.

While the insulating ring 100 is applied in a cylindrical lithium ion battery, it matches the battery core 10. As shown in FIG. 3, the two sector-shaped protruding parts 8 forms a groove and the core rod 9 of the battery core 10 is fixed in the groove so that movement of the core rod 9 in the battery core 10 may be avoided.

Meanwhile, while the sector-shaped positioning protruding part 8 fixes the core rod 9, the leading out tabs 11 of the battery core 10 penetrate through the tab hole 6. As shown in FIG. 4, the tab hole 6 holds the tab 11 effectively to avoid movement of the tab 11.

Therefore, while the battery is impacted by an outer force or vibrating, the protruding parts 8 forming a positioning groove holds the core rod 9, the tab hole 6 holds and fixes the tab 11. Both core rod 9 and tab 11 will not easily move and will not easily contact with each other, so that short circuit caused by contact of the core rod 9 and tab 11 may be avoided. In this case, the safety performance of the cylindrical lithium ion batteries may be improved.

It will be apparent to those skilled in the art that variations and modifications of the present invention may be made without departing from the scope or spirit of the present invention. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1-13. (canceled)

14. An insulating disk for a battery, comprising:
a positioning member configured to secure a core rod of the battery at the center of the disk, wherein the positioning member comprises a solid central portion of the disk and at least two protruding parts extending from the central portion, wherein the positioning member is configured so that the core rod abuts the central portion of the disk and is held in place laterally by the at least two protruding members; and
at least one hole in the disk configured to allow a tab of the battery to pass therethrough.

15. The disk of claim 14, wherein at least one of the protruding parts extends about 1-3 mm from the central portion of the disk.

16. The disk of claim 14, wherein the thickness of the protruding parts is about 0.2-0.5 times of the thickness of the insulating disk.

17. The disk of claim 14, wherein the two protruding parts connect with each other to form a sleeve on the disk.

18. The disk of claim 14, wherein the two protruding parts face each other spaced at a predetermined interval.

19. The disk of claim 18, wherein the protruding parts are sector-shaped.

20. The disk of claim 14, wherein the protruding parts and the disk form an integral structure.

21. The disk of claim 14, which comprises two holes adjacent to the positioning member.

22. An insulating disk for a battery, comprising:
a positioning member configured to secure a core rod of the battery at the center of the disk, wherein the positioning member comprises a solid central portion of the disk and at least two protruding parts extending from the central portion, wherein the positioning member is configured so that the core rod abuts the central portion of the disk and is held in place laterally by the at least two protruding members;
two holes in the disk configured to allow a tab of the battery to pass therethrough; and
at least one via hole in the disk configured to allow an electrolyte to be injected into the battery.

23. The disk of claim 22, which comprises a plurality of via holes.

24. The disk of claim 23, wherein the via holes are located along a circumferential direction of the disk at even intervals.

25. The disk of claim 22, wherein the shape of the via hole is selected from the group consisting of a circle, a sector, a quadrangle, a triangle, and a circular-arc.

26. A battery comprising:
a cylindrical shell;
an electrolyte encapsulated in the cylindrical shell;
a battery core disposed in the cylindrical shell, having a core rod and a tab; and
an insulating disk closing the cylindrical shell, comprising:
a positioning member configured to secure a core rod of the battery at the center of the disk, wherein the positioning member comprises a solid central portion of the disk and at least two protruding parts extending from the central portion, wherein the positioning member is configured so that the core rod abuts the central portion of the disk and is held in place laterally by the at least two protruding members; and
at least one hole in the disk configured to allow a tab of the battery to pass therethrough.

27. The battery of claim 26, which is a lithium ion battery.

28. The battery of claim 26, wherein the protruding parts and the insulating disk form an integral structure.

29. The battery of claim 26, wherein at least one of the protruding parts extends about 1-3 mm from the central portion of the disk.

30. The battery of claim 26, wherein the thickness of the protruding parts is about 0.2-0.5 times of the thickness of the insulating disk.

31. The battery of claim 26, wherein the protruding parts are sector-shaped.

32. The battery of claim 26, wherein the insulating disk further comprises at least one via hole configured to allow an electrolyte to be injected into the battery.

33. The battery of claim 32, wherein the insulating disk comprises a plurality of via holes.
